(19) United States
(12) Patent Application Publication
(10) Pub. No.: US 2011/0203038 A1
(43) Pub. Date: Aug. 25, 2011

(54) CUSTOM FIT HELMET AND ITS METHOD OF MAKING

(76) Inventor: James Donald Jones, JR., Stokesdale, NC (US)

(21) Appl. No.: 12/708,627

(22) Filed: Feb. 19, 2010

(51) Int. Cl. A42B 3/12; B29C 67/20

(52) U.S. Cl. 2/411; 264/40.1; 264/442

(57) ABSTRACT

A helmet is made by the steps of measuring the geometry of human head to map its contour, selecting an appropriately sized unfinished helmet having an oversized thick foam liner with an unfinished interior surface, collapsing selected areas of said foam liner by using an ultrasonic tool to heat said selected areas to provide a finished interior surface having a predetermined shape conforming to said contour of said human head. The helmet comprises a helmet shell with an interior-facing liner having selected areas of collapsed foam which provide an interior facing foam liner surface which conforms to a predetermined geometry of a human head.

### FIELD OF THE INVENTION

The present invention relates to a helmet and to its method of making. In a preferred embodiment, the present invention relates to a method of making a custom fit crash helmet for use by motorcyclists and the like.

### BACKGROUND OF THE INVENTION

In certain situations, people wisely wear protective headgear such as helmets to protect themselves against head trauma. For example, helmets are commonly worn by people riding motorcycles, racing cars or playing American football. Although helmets have been used for many years there remains room for improvements in helmets, particularly for improvements in personal comfort.

A proper fitting helmet is essential for personal comfort but a proper fit of helmet to head is also necessary to maximize protection of the head. A proper fitting helmet can be obtained by measuring or determining the geometry of a person's head and then constructing the helmet to fit the geometry of the person who is going to wear it. Unfortunately, the presently known methods of making custom fit helmets take quite a while to produce a custom fit helmet and are expensive. It is believed the relatively high cost of custom fit helmets leads many people to choose “off the shelf” helmets rather than custom fit helmets. These choices, however, may compromise their safety.

Thus, there is a need for a practical method of making custom fit helmets which could quickly produce helmets at a reasonable cost. It would be particularly desirable if the helmets produced by the method potentially offered improved protection. Such a method would increase the usage of custom fit helmets to thereby enhance overall safety. Of course, users would also benefit by enjoying the increased comfort level afforded by a custom fit helmet and the potentially improved protection of the helmet. It would also be desirable if the method employed apparatus which was so inexpensive that small retailers could afford it. These small retailers would likely be located near potential customers. This would benefit both the retailer who could profit from increased sales and the customers who could enjoy the convenience of a nearby source of custom fit helmets. Convenient, personal service should also increase the number of people taking advantage of the service and thereby increasing overall safety.

As described in detail hereinafter, the present invention meets the above need and offers the aforementioned advantages. The present invention provides an improved method for making a custom fit helmet such as a crash helmet or motorcycle helmet. The method is practical and economical and requires use of relatively inexpensive equipment which will be affordable to smaller retail shops. The resulting product, a custom fit helmet, will be comfortable to the user and will be comparatively safer than an ill fitting helmet. These and other advantages of the present invention will be apparent from the following disclosure and claims taken in conjunction with the accompanying drawings.

### SUMMARY OF THE INVENTION

A helmet is made by the steps of measuring the geometry of human head to map its contour, selecting an appropriately sized unfinished helmet having an oversized foam liner with an unfinished interior surface, collapsing selected areas of said foam liner by using an ultrasonic tool to heat said selected areas to provide a finished interior surface having a predetermined shape conforming to said contour of said human head. The helmet comprises a helmet shell with an interior-facing liner having selected areas of collapsed foam which provide an interior facing foam liner surface which conforms to a predetermined geometry of a human head.

### BRIEF DESCRIPTION OF THE DRAWINGS

FIG. 1 is a perspective view of a preferred embodiment of a motorcycle helmet of the present invention with a portion broken away;

FIG. 2 is a left side elevational view of a helmet blank with its liner removed and with a portion of its hard shell broken away to show a portion of its foam liner in section;

FIG. 3 is a perspective view of a preferred embodiment of a device for measuring the geometry of a human head in accordance with a preferred embodiment of a method of this invention; and

FIG. 4 is a perspective view of a preferred embodiment of an apparatus for machining the interior facing surface of a liner of this invention in accordance with a preferred embodiment of a method of this invention.

### DETAILED DESCRIPTION OF THE INVENTION

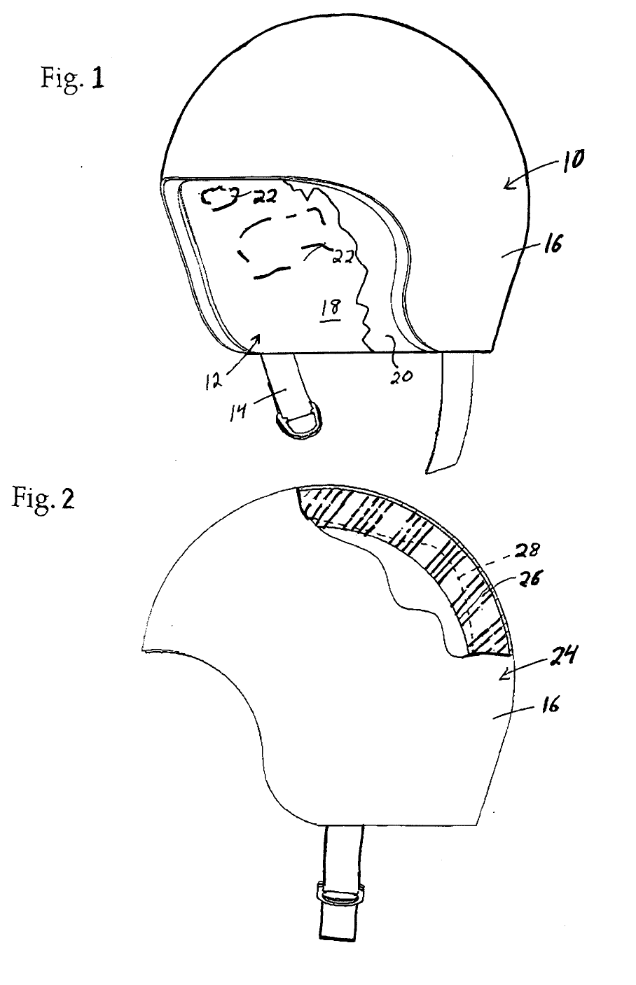

Now referring to FIG. 1, a custom fit helmet of the present invention is shown and indicated generally by the numeral 10. Custom fit helmet 10 has a generally conventional outer shape for use as a motorcycle crash helmet but has a custom shaped foam liner made in accordance with the present invention. Helmet 10 has a generally hollow interior 12 to receive the head of a particular user and has chin strap 14 for retention of the helmet on the head of the user. Helmet 10 comprises an outer hard shell 16 and an inner foam liner 18 which is covered by a conventional fabric liner 20. Foam liner 18 has contours 20 therein which have been formed to shape the inwardly facing surface of foam liner 18 to conform to the geometric contour of the particular user's head.

The structure of helmet 10 will be further understood from the following description of its method of making. Generally speaking, the present invention is a method of making a helmet having a foam liner which is custom fit to a particular user, the method comprising the steps of:

(1) Providing a set of surface data points obtained by measuring the contour of a portion of a human head to be covered by said helmet;

(2) providing an unfinished helmet having a foam liner having an inwardly facing surface and having an average cross-sectional thickness greater than that desired in the finished product;

(3) using ultrasonic energy to collapse selected areas of said foam to provide an inwardly facing surface having a preselected contour based on said set of surface data points and which therefor conforms to a corresponding contour of the head of an intended user.

The resulting helmet of the present invention comprises a hard helmet shell with an interior-facing foam liner having selected areas of collapsed foam which provide an interior facing foam liner surface which conforms to a predetermined geometry of a human head.

It is contemplated that different sizes of unfinished helmets with “oversized” foam liners will be used to accommodate the various sizes and shapes of heads of the intended users which will be encountered. It is further contemplated that the system of the present invention will produce superior fitting helmets at a reasonable cost and will shorten lead times as compared to more complex custom fit systems. It is further contemplated that the areas of collapsed foam will be somewhat more dense and may offer more protection to the user than if such areas were made by simply routing out the foam.

Now referring to FIG. 2, an unfinished helmet, i.e., a helmet blank, is indicated generally by the numeral 24. Helmet blank 24 is shown with its fabric liner removed and with a portion of its hard shell 16 broken away to show a cross-section of a portion of its foam liner. As shown in FIG. 2, unfinished helmet 24 has a foam liner 26 which is relatively thick, having an average cross-sectional thickness greater than that desired in the end product. Thus, foam liner 26 can by milled or shaped by reducing the thickness of selected areas thereof to provide an inwardly facing surface with a preselected contour which corresponds to the head of the user. As illustrated in FIG. 2, a desired contour is indicated by dashed line 26 and it is intended that foam liner 26 will be reduced in thickness in the area shown in FIG. 2 to conform to line 28.

The helmets of this invention are intended for users with heads having many different shapes and sizes. The preselected contour of the inner liner foam is determined by the particular shape of the head of the intended user and in most cases this shape must by mapped or measured by some means. Such measurement is also necessary information for selecting an unfinished helmet of a proper size. So an initial step of this invention is to obtain a set of surface data points by mapping, measuring or otherwise quantifying in three dimensions the contour surface of a portion of a particular intended user's head so that a custom-fit helmet can be constructed.

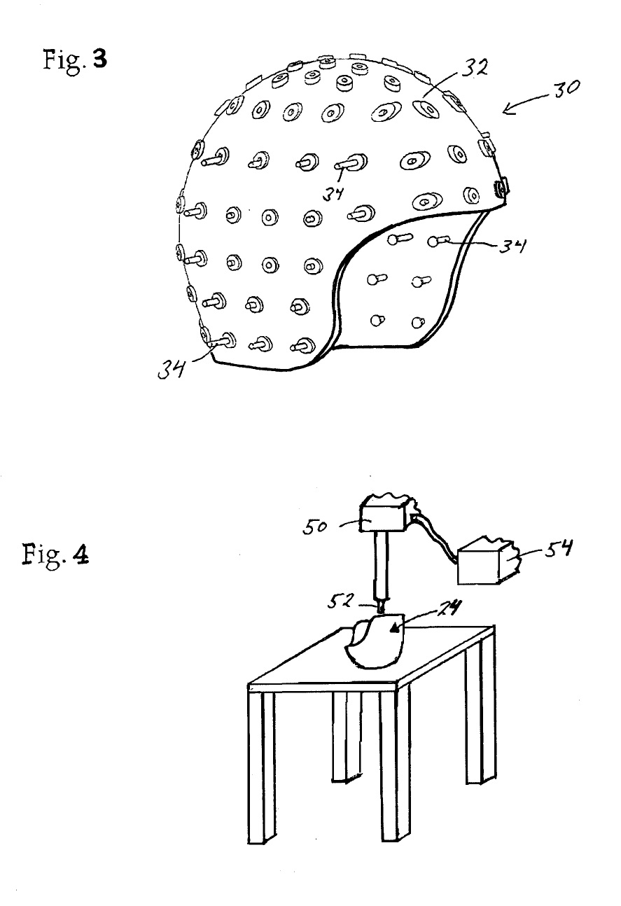

A head measuring apparatus suitable for use in the present invention is illustrated in FIG. 3 and indicated generally by the numeral 30. Apparatus 30 is a standard helmet shell 32 which has been equipped with a plurality of elongated probes 34 which are longitudinally slidably located in apertures at selected locations about shell 32. After a user puts on helmet 32, each probe 34 can be pushed longitudinally inwardly until contacting the wearer's head whereupon the longitudinal position of the probe can be noted. The noted positions of all of the probes 34 will provide a set of surface data points in three dimensions which can be processed to map the contour of the wearer's head, which map will then be used to machine the inner surface of a foam liner blank to conform to the same contour and hence to fit the wearer's head. Probes 34 can have graduations marked on each probe shaft to provide manual measurement of each probe location. Alternatively, each probe 34 can be electronically positioned with linear encoders for recording the positions thereof.

The data obtained from the measuring step is used to select an appropriately sized unfinished helmet blank having a relatively thick foam liner suitable for shaping to have an interior facing surface of a predetermined contour which will conform to the users head. Shaping is preferably carried out using an ultrasonic welder coupled to a CNC machine as is illustrated in FIG. 4. Thus, as shown in FIG. 4, an ultrasonic welder 50 with probe 52 is controlled by CNC machine 54 which has been programmed with contour data obtained from the measuring step described above to shape the foam liner of the unfinished helmet to provide a finished helmet which has a contour which corresponds to the contour of the user's head.

Helmet liners are made of a material which is selected for the intended end use of the helmet. It is desired that the liner is soft and thick so the head will decelerate at a gentle rate as it sinks into the liner during a collision. The thickness of the liner is limited by the practical thickness that will fit into a helmet shell. The stiffness of the foam depends upon contemplated impact speed of the helmet. Most helmet tests use speeds between 7 and 7 m/s (9 and 16 mph, 14 and 25 km/h). The particular foam liner material to be used in the present invention will be chosen by one skilled in the art.

The present invention is described by reference to one of its preferred embodiments, namely, a method of making a motorcycle helmet and the motorcycle helmet so made. However, it will be appreciated that the invention is broadly applicable to helmets intended for other uses and for other foam products such as seats and the like. Also, while the preferred embodiment employs an unfinished helmet having an attached foam liner, alternate embodiments might employ separate shells and foam liners. A preferred method for obtaining the measurement for designing the preselected contour is described in some detail. However, it will be appreciated by those skilled in the art that any method for obtaining the measurements necessary to define the preselected contour may be used within the broad scope of the present invention.

What is claimed is:

1. A method of making a helmet custom-fit to the contour of a head of an intended user comprising the steps of:
Providing a set of surface data points by measuring the contour of a portion of the head of the intended user;
providing an unfinished helmet having a foam liner having an inwardly facing surface and having an average cross-sectional thickness greater than that desired in the finished product;
shaping said foam liner to provide an inwardly facing surface based on said set of surface data points to thereby provide a preselected contour which conforms to the corresponding contour of the head of the intended user.

2. The method of claim 1 wherein said foam is shaped by collapsing portions thereof with ultrasonic energy.

3. The method of claim 1 wherein said set of surface data points are determined by measuring said head using a measuring helmet with a plurality of linear probes.

4. The method of claim 1 wherein said ultrasonic energy is provided by an ultrasonic horn.

5. The method of claim 1 wherein said liner is shaped by ultrasonic energy directed by a CNC apparatus.

6. A helmet custom shaped to fit a head of an intended user, the helmet comprising a hard helmet shell and an interior-facing liner having selected areas of collapsed foam which provide an interior facing foam liner surface which conforms to a predetermined geometry of the head of said intended user.

7. A helmet as in claim 6 wherein said foam is has areas which have greater density than other areas of said foam.
